(19) United States
(12) Patent Application Publication
(10) Pub. No.: US 2016/0321668 A1
(43) Pub. Date: Nov. 3, 2016

(54) SYSTEM AND METHOD FOR ENHANCING SECURITY PROTECTION OF AN ELECTRONIC TRANSACTION IN ONLINE ENVIRONMENT

(71) Applicant: NHN Entertainment Corporation, Seongnam-si (KR)

(72) Inventor: Myunghwan CHOI, Seongnam-si (KR)

(21) Appl. No.: 15/141,230

(22) Filed: Apr. 28, 2016

(30) Foreign Application Priority Data
Apr. 28, 2015 (KR) 10-2015-0059539

(51) Int. Cl. G06Q 20/40; G06Q 20/38; G06F 17/30; G06Q 20/34; G06Q 20/32

(52) U.S. Cl. CPC G06Q 20/4016; G06Q 20/4014; G06Q 20/34; G06Q 20/3223; G06F 17/30312; G06Q 20/385

(57) ABSTRACT

A system and method for enhancing a security of electronic transactions in an unsecured public network, such as the Internet, includes a first server such as a payment gateway server and a second distinct server, such as card issuer server, in which user information and a user account number is received from a user; a virtual number is generated based on the user account number, the virtual number representing the user account number; user mapping information is generated by correlating the virtual number and the user information; account mapping information is generated by correlating the virtual number and the user account number; the user mapping information is stored in the first server; and the account mapping information is stored in the second, distinct server. The systems and methods may further include a one time password feature to further enhance security and reduce the likelihood of fraud in electronic transactions occurring over the Internet or other unsecured networks.

### CROSS REFERENCE TO RELATED APPLICATION

This application claims priority from and the benefit of Korean Patent Application No. 10-2015-0059539, filed on Apr. 28, 2015, which is hereby incorporated by reference for all purposes as if fully set forth herein.

### BACKGROUND

1. Field

Exemplary embodiments relate to a system and method for more secure electronic transactions, and, more particularly to a system and method for enhancing security and reducing the risk of theft of personal and financial account information used in online electronic transactions, such as the purchase of merchandise in an online environment through an unsecured network such as the Internet.

2. Discussion of the Background

Recently, due to the advent of electronic commerce and improved computing devices, consumers having a computing device, for example PC (Personal Computer), smartphone, tablet PC and the like, can purchase merchandise such as a desired product and/or service through conventional electronic transaction processes over the Internet. Generally, the conventional electronic transaction process includes a user performing the following steps: selecting a product or service, clicking a payment button through a computing device, displaying a payment window, consenting to terms and conditions, selecting a payment method, selecting a credit or debit card to be used to pay for the product, inputting card account information and authentication information, confirming the payment, and receiving final acceptance of the payment to be processed for finalizing the payment.

However, the conventional electronic transaction process is complicated and time-consuming because the numerous steps and additional programs, for example, ActivX, are required for performing at least some of the numerous steps.

In order to streamline the conventional, online electronic transaction process, some payment methods require using only a password to simplify the transaction process. This password method uses payment gateway authentication and card issuer authentication.

The payment gateway authentication refers to a payment method which, when a user initially inputs card account information through a computing device over a communication network, a payment gateway (e.g. server) generates mapping information by correlating the card account information with the user identification and stores the mapping information. When the user identification is subsequently transmitted to the payment gateway according to user's purchase decision, the payment gateway transmits the card information according to the mapping information corresponding to the received user identification to the card issuer to process the payment.

The card issuer authentication refers to a payment method which, when a user initially inputs card account information through a computing device over a communication network, the card issuer, instead of the payment gateway, generates a mapping information by correlating the card account information with the user identification and stores the mapping information. When the user identification is subsequently transmitted to the payment gateway according to user's purchase decision, the payment gateway transmits the user identification to the card issuer, and the card issuer processes the payment.

However, the payment gateway authentication requires that the card account information be stored in the payment gateway, and therefore, has a potential risk of security breach of card information from the payment gateway. For example, even when a merchant, e.g., Internet shopping service, changes a payment gateway, the user's card information may be stored in the previous payment gateway server and the card information stored in the previous payment gateway server may be breached by thieves or hackers.

On the other hand, the card issuer authentication limits operation of the merchant system more than the payment gateway authentication. More particularly, for example, the merchant system may not modify card information interface according to the card issuer's policy, and/or the merchant system may not manage user information, e.g., changing the user identification information, because the user identification is stored in the card issuer's system.

Both the payment gateway authentication and the card issuer authentication suffer from security issues and inconvenience. Indeed the stealing of user's personal and payment account information from on-line servers and databases has become a wide spread problem unique to the advent of online electronic commerce and purchasing goods and services over the Internet and other unsecure networks.

The above information in this Background section is only for enhancement of understanding of the background of the inventive concept, and, therefore, it may contain information that does not form the prior art that is already known in this country to a person of ordinary skill in the art.

### SUMMARY

As discussed in more detail below and in the exemplary embodiments described in the detailed description, the invention addresses the need for a simpler electronic transactions system and method that facilitates electronic transactions while at the same time providing enhanced security and protection for user and card account information.

Exemplary embodiments provide an electronic transaction system and method using one or more a virtual numbers that enable user information and card account information for online electronic transactions to be stored separately thereby reducing the risk of breach and theft of personal and financial information stored in a single database or server in an unsecured, online environment.

In a first exemplary embodiment, a method for enhancing a security of an electronic transaction system including a first server and a second server includes: receiving a user information and a user account number from a user; generating a virtual number based on the user account number, the virtual number representing the user account number; generating a user mapping information by mapping the virtual number and the user information; generating a account mapping information by mapping the virtual number and the user account number; storing the user mapping information in a first server; and storing the account mapping information in a second server distinct from the first server.

The method for enhancing a security of an electronic transaction system may further include: transmitting a request for a payment received from a user to a merchant server, the request for payment including the user information and merchandise selection information; providing the user information to the first server; extracting, by the first server, the virtual number from the user mapping information corresponding to the received user information; transmitting the extracted virtual number to the second server; extracting, by the card issuer server, the user account number from the account mapping information corresponding to the virtual number; and processing the payment using the extracted user account number.

The method for enhancing a security of an electronic transaction system may further include use of an one time password (OTP). For example, the method may further include generating an one time password (OTP) to validate at least one of the user device and the merchant server.

In a second exemplary embodiment, an electronic transaction system for enhancing security protection of an electronic transaction in an unsecured online environment includes: a payment gateway server including a database including a user mapping information, wherein the user mapping information includes a user information and a virtual number mapped to each other, and wherein the payment gateway server is configured to receive the user information and extract the virtual number from the user mapping information which corresponds to the received user information.

In a third exemplary embodiment, an electronic transaction system for enhancing security protection of an electronic transaction in unsecured online environment includes: a card issuer server including a database including an account mapping information, wherein the account mapping information includes a user account information and a virtual number mapped to each other, and wherein the card issuer server is configured to receive the virtual number and extract the user account information from the account mapping information which corresponds to the received virtual number.

Additional aspects and features of the invention are be set forth in the detailed description which follows, and, in part, will become apparent from the disclosure, or may be learned by practice of the inventive concept.

The foregoing general description and the following detailed description are exemplary and explanatory and are intended to provide further explanation of and not limit the claimed subject matter, which is defined solely by the appended claims.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, to each other with the description, serve to explain principles of the inventive concept.

FIG. 1 is a diagram illustrating an electronic transaction system according to one or more exemplary embodiments of the invention.

FIG. 2 illustrates mapping information stored, respectively, in the payment gateway server and the card issuer server of the electronic transaction system of the FIG. 1.

FIG. 3 is a flow chart illustrating a method for electronic transaction according to one or more exemplary embodiments of the invention.

FIG. 4 is a diagram illustrating a first exemplary embodiment for storing the first and second mapping information of FIG. 3.

FIG. 5 is a diagram illustrating a second exemplary embodiment for storing the first and second mapping information of FIG. 3.

FIG. 6 is a diagram illustrating a third exemplary embodiment for storing the first and second mapping information of FIG. 3.

FIG. 7 is a diagram illustrating a fourth exemplary embodiment for storing the first and second mapping information of FIG. 3.

FIG. 8 is a diagram illustrating an exemplary embodiment for the payment process of FIG. 3.

FIGS. 9, 10, and 11 are series of diagrams illustrating an exemplary embodiment of the payment process of the FIG. 3 using an One Time Password (OTP) of the invention generated by the payment gateway server.

FIGS. 12 and 13 are diagrams illustrating other exemplary embodiments of the payment process of the FIG. 3 using the OTP generated by the payment gateway server.

FIGS. 14, 15 and 16 are series of diagrams illustrating an exemplary embodiment of the payment process of the FIG. 3 using the OTP of the invention generated by the card issuer server.

FIGS. 17 and 18 are diagrams illustrating other embodiments of the payment process of the FIG. 3 using the OTP generated by the card issuer server.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of regions, etc., may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section for clarity. Thus, a first element, component, region, and/or section discussed below could be termed a second element, component, region, and/or section without departing from the teachings of the present disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, one or more exemplary embodiments of an electronic transaction system and method for use making financial transaction over the Internet or in other unsecure networks will be described in detail.

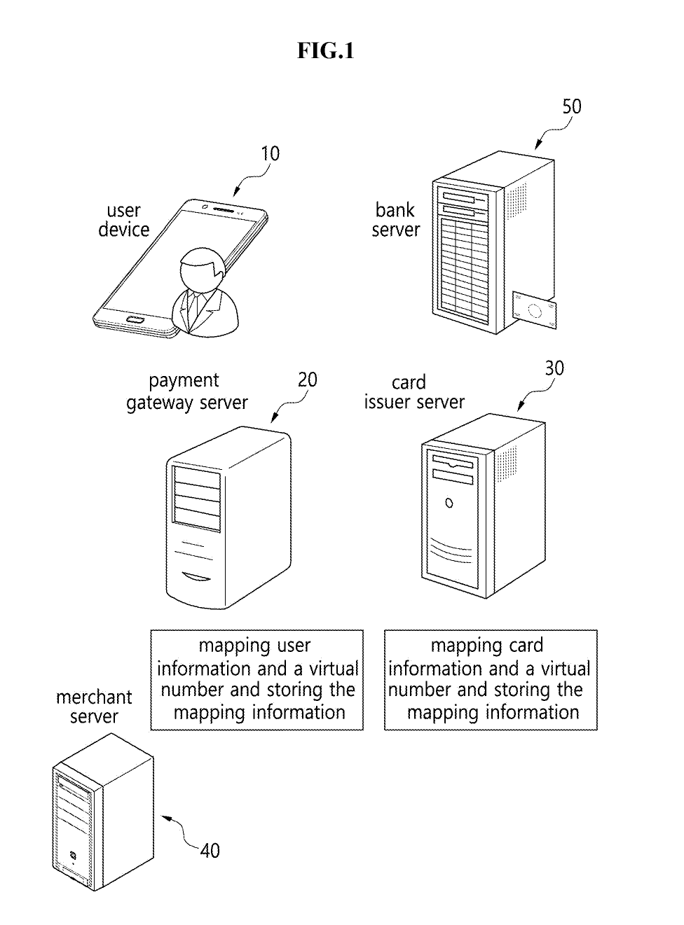

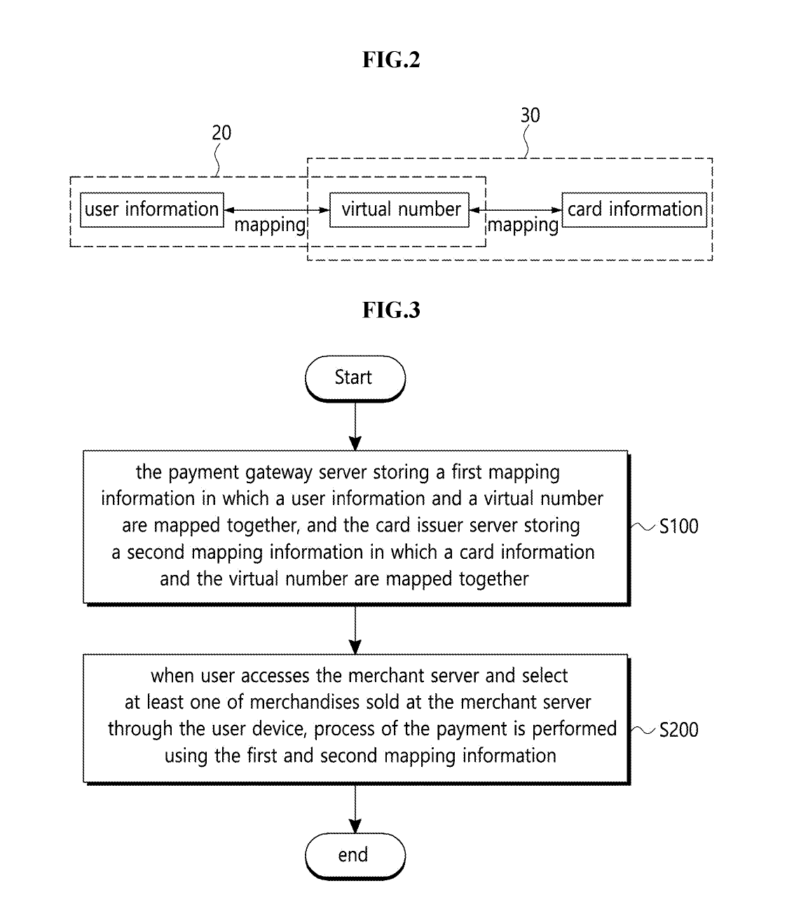

FIG. 1 is a diagram illustrating an electronic transaction system according to one or more exemplary embodiments, and FIG. 2 illustrates mapping information stored, respectively, in a payment gateway server and a card issuer server of the electronic transaction system of the FIG. 1.

Referring to FIG. 1 and FIG. 2, a system for a electronic transaction comprises a user device 10, a payment gateway server 20, a card issuer server 30, and a merchant server 40. The user device 10, payment gateway server 20, card issuer server 30, and merchant server 40 may exchange data each other via a wired or wireless communication network including, but not limited to the, Internet or other unsecure network.

The user device 10 is a digital electronic device that an user may use for purchasing a merchandise through the communication network. The user device 10 may include, for example, a mobile computing device such as a smartphone, tablet PC, and personal digital assistant (PDA) or a personal computing device such as desktop PC and notebook PC, that are capable of communicating with other digital device via the communication network.

The payment gateway server 20 may include a computer system, which is configured to provide a payment gateway service, and store a first mapping information generated by correlating a user information and a virtual number to each other. The user information is personal information about or specific to a user. For example, the user information of a user A may be a unique identification of the user A, such as a social security or other unique number, name, address or information specific to a given user.

The card issuer server 30 may include a computer system, which is configured to provide a payment service by a credit card, a debit card and an account, and store a second mapping information generated by correlating a card account information and a virtual number to each other. The card account information is information unique to a card owned by the user, for example, the card number of a credit card and account number of the user A.

More specifically, each of the payment gateway server 20 and the card issuer server 30 may include a processor, a data bus, a network interface, a memory, and a database. The memory may include an operating system (OS) and a payment process routine. According to one or more exemplary embodiments, each of the payment gateway server 20, the card issuer server 30, and the merchant server 40 may further include additional constituent elements.

The memory may include a permanent mass storage device, such as a random access memory (RAM), a real only memory (ROM), and a disc drive, as a computer-readable storage medium. Also, program codes for the OS, the payment process routine, and the like may be stored in the memory. Such software constituent elements may be loaded from another computer-readable storage medium separate from the memory using a drive mechanism (not shown). The other computer-readable storage medium may include, for example, a floppy drive, a disc, a tape, a DVD/CD-ROM drive, and a memory card. Software constituent elements may also be loaded to the memory through the network interface instead of using the computer-readable storage medium. The data bus enables communication and data transmission between the constituent elements of the payment gateway server. The data bus may include at least one of a high-speed serial data bus, a parallel data bus, a storage area network (SAN), and/or another appropriate communication technology. The network interface may be a computer hardware constituent element for connecting the payment gateway server to the computer network. The network interface may be configured to connect the payment gateway server to the computer network through a wireless or wired connection. The database may be configured to store and maintain at least a part of the information associated with a payment gateway service or a payment process. For example, the database included in the payment gateway server 20 may be configured to store a first mapping information in which the user information and the virtual number are correlated to each other, and the database included in the card issuer server 30 may be configured to store a second mapping information in which the card information and the virtual number are correlated to each other. In addition to the first mapping information and second mapping information, the database may store and maintain additional information, for example, a mobile phone number, a coupon number, and a gift certificate number, in association with the user information. Although that data base is included in the payment gateway server according to the exemplary embodiment, the exemplary embodiments are not limited thereto, and the database may be an external database disposed in a separate system. The processor may be configured to execute computer-readable instructions of a computer program by performing basic calculations, logical operations, and input/output operations of the payment gateway server. The computer-readable instructions may be provided from the memory or the network interface to the processor through the data bus. For example, the processor included in the payment gateway server 20 may be configured to may be configured to execute program codes or the computer-readable instructions dedicated to providing the payment gateway service, and the processor included in the card issuer server 30 may be configured to execute program codes or the computer-readable instructions dedicated to providing a payment service. The program codes may be stored in a storage device such as the memory.

According to the exemplary embodiments, the user information and the card information are not directly correlated to or associated with each other, but rather are indirectly associated with each other through the virtual number. In other words, the virtual number is a number generated to link the user information and the card information to be used for payment by the user. A virtual number, which is exclusively assigned to one card or account, may be a random number or a number generated based on a predetermined generation rule.

The merchant server 40 may include a computer system configured to process sales of merchandise, in association with the payment gateway server and the card issuer server, via a communication network. The merchandise may be tangible products, e.g., clothes, electronic devices, accessories and the like, or intangible products, e.g., software, services and the like.

The user device 10 accesses the merchant server 40 to select one of the merchandises sold on the merchant server 40. The user device, then, can process a payment for the selected merchandise using the first mapping information stored, e.g., in the payment gateway server 20 and the second mapping information stored, e.g., in the card issuer server 30.

According to the exemplary embodiment the payment gateway server 20 stores a first mapping in which a user information and a virtual number are correlated to each other, and the card issuer server 30 stores a second mapping information in which a card information and the virtual number are correlated to each other. In other words, the payment gateway server 20 stores the virtual number but does not store the card information. Therefore, the exemplary embodiments provide enhanced security and improved protection to the users against the security breach of the card information even when the merchant changes the payment gateway, because the payment gateway server only stores the virtual number instead of the card information.

According to the exemplary embodiments, the system and methods for electronic transactions of the invention may be configured both to generate the virtual number and store the first and second mapping information at different locations.

According to the exemplary embodiments, the payment gateway server 20 may be configured to generate the virtual number, and the first and second mapping information may be generated and stored using the virtual number.

More specifically, the user device 10 may transmit the user information and the card information, which may be stored in the user device 10 or input by the user, to the payment gateway server 20. The payment gateway server 20 may be configured to generate the virtual number representing the card information received from the user device 10. The payment gateway server 20 may be configured to generate the first mapping information by correlating the user information received from the user device and the virtual number generated by the payment gateway server 20 to each other, and store the first mapping information. The payment gateway server 20 may transmit the card information and the virtual number to the card issuer server 30. The card issuer server 30 may be configured to generate the second mapping information by correlating the card information and the virtual number received from the payment gateway server 20 to each other, and store the second mapping information.

According to the exemplary embodiments, the card issuer server 30 may be configured to generate the virtual number, and the first and second mapping information may be generated and stored using the virtual number on the card issuer server 30.

More specifically, the user device 10 may transmit the user information and the card information, which may be stored in the user device 10 or input by the user, to the card issuer server 30. The card issuer server 30 may be configured to generate the virtual number representing the card information received from the user device 10. The card issuer server 30 may be configured to generate the second mapping information by correlating the card information and the virtual number received from the payment gateway server 20 to each other, and store the second mapping information. The card issuer server 30, then, may transmit the user information and the virtual number to the payment gateway server 20. The payment gateway server 20 be configured to generate the first mapping information by mapping the user information and the virtual number received from the card issuer server 30 to each other, and store the first mapping information.

According to the exemplary embodiments, the user device 10 may be configured to generate the virtual number, and the first and second mapping information may be generated and stored using the virtual number on the user device 10.

More specifically, the user device 10 may be configured to generate a virtual number representing the card information which may be stored in the user device 10 or input by the user. The user device 10, then, may transmit the user information and the virtual number to the payment gateway server 20, and transmit the card information and the virtual number to the card issuer server 30. The payment gateway server 20 may be configured to generate the first mapping information by correlating the user information and the virtual number received from the user device 10 to each other, and store the first mapping information. The card issuer server 30 may be configured to generate the second mapping information by mapping the card information and the virtual number received from the user device 10 to each other, and store the second mapping information.

According to the further exemplary embodiments, the merchant server 40 may be configured to generate the virtual number, and the first and second mapping information may be generated and stored using the virtual number on the merchant server 40.

More specifically, the user device 10 may transmit the user information and the card information, which may be stored in the user device 10 or input by the user, to the merchant server 40. The merchant server 40 may be configured to generate the virtual number representing the card information received from the user device 10. The merchant server 40, then, may transmit the user information and the virtual number to the payment gateway server 20, and transmit the card information and the virtual number to the card issuer server 30. The payment gateway server 20 may be configured to generate the first mapping information by correlating the user information and the virtual number received from the merchant server 40 to each other, and store the first mapping information. The card issuer server 30 may be configured to generate the second mapping information by correlating the card information and the virtual number received from merchant server 40 to each other, and store the second mapping information.

According to the exemplary embodiments, the system for electronic transaction may process the payment for purchase using the first and second mapping information. More specifically, a user may access the merchant server 40, determine which merchandise to purchase, and process the payment through the user device 10, using the first mapping information stored in the payment gateway server 20 and the second mapping information stored in the card issuer server 30.

For example, the user may access the merchant server 40 and select at least one of merchandises sold at the merchant server 40 through the user device 10, and the user device 10 may transmit a transaction request to the merchant server 40. The transaction request includes merchandise selection information and the user information. The merchant server 40 transmits the user information to the payment gateway server 20. The payment gateway server 20 extracts the virtual number from the first mapping information which corresponds with the user information received from the merchant server 40, and then transmits the extracted virtual number to the card issuer server 30. The card issuer server 30 extracts the card information from the second mapping information which corresponds with the virtual number received from the payment gateway server, and then processes the payment for the merchandise using the extracted card information.

According to the payment process of the exemplary embodiments, for example, the card issuer server 30 may access a bank server 50 to make the payment to a merchant account associated with the merchant server 40 promptly, after certain time period, or at certain date and time. The bank server 50 of the user account and the bank server 50 of the merchant account may be same or different.

According to the exemplary embodiments, the payment process may include OTP (One Time Password) to further enhance the security of any transaction. The OTP may be generated by the payment gateway server 20 or the card issuer server 30.

According to one of the exemplary embodiments, the OTP may be generated by the payment gateway server 20. When the user accesses the merchant server 40 and selects at least one merchandise sold at the merchant server 40 through the user device 10, then the user device 10 may transmit a transaction request to the merchant server 40. The transaction request includes a merchandise selection information and the user information. The merchant server 40 transmits the user information to the payment gateway server 20. The payment gateway server 20, in response to receiving the user information, generates an OTP (One Time Password) and transmits the OTP to the user device 10. The user device 10 may provide the user with a user interface displaying the OTP received from the payment gateway server 20 and receive a user input confirming the OTP. The user device 10, in response to the user input, transmits the user input confirming the OTP to the payment gateway server 20. The payment gateway server 20, in response to determining that the generated OTP matches the user input confirming the OTP, is configured to extracts the virtual number from the first mapping information which corresponds with the user information received from the merchant server 40, and transmits the extracted virtual number to the card issuer server 30. The card issuer server 30 is configured to extract the card information from the second mapping information which corresponds with the virtual number received from the payment gateway server, and process the payment for the merchandise using the extracted card information.

According to the another of the exemplary embodiments, the OTP may be generated by the payment gateway server 20. When the user accesses the merchant server 40 and selects at least one of the merchandises sold at the merchant server 40 through the user device 10, then the user device 10 may transmit a transaction request to the merchant server 40. The transaction request includes a merchandise selection information and the user information. The merchant server 40 transmits the user information to the payment gateway server 20. The payment gateway server 20, in response to receiving the user information, generates the OTP and transmits the OTP to the user device 10. The user device 10, in response to receiving the OTP from the payment gateway server 20, may provide the user with a user interface to receive a final acceptance of the payment from the user confirming the payment. The user device 10, in response to receiving the final acceptance of the payment from the user, may be configured to return the OTP as received from the payment gateway server 20 back to the payment gateway server 20. The payment gateway server 20, in response to determining that the returned OTP matches the generated OTP, is configured to extracts the virtual number from the first mapping information which corresponds with the user information received from the merchant server 40, and transmit the extracted virtual number to the card issuer server 30. The card issuer server 30 is configured to extract the card information from the second mapping information which corresponds with the virtual number received from the payment gateway server, and process the payment for the merchandise using the extracted card information.

According to further exemplary embodiments, the OTP may be generated by the payment gateway server 20. When the user accesses the merchant server 40 and selects at least one of the merchandises sold at the merchant server 40 through the user device 10, then the user device 10 may transmit a transaction request to the merchant server 40. The transaction request includes a merchandise selection information and the user information. The merchant server 40 transmits the user information to the payment gateway server 20. The payment gateway server 20, in response to receiving the user information from the merchant server 40, generates the OTP and transmits the OTP to the merchant server 40. The merchant server 40, in response to receiving the OTP from the payment gateway server 20, transmits a request for final acceptance of the payment for the user device 10. The user device 10, in response to receiving the request for final acceptance of the payment from the merchant server 40, may be configured to provide the user with a user interface to receive the final acceptance of the payment from the user. The user device 10, in response to receiving the final acceptance of the payment from the user, may be configured to transmit the final acceptance of the payment to the merchant server 40. The merchant server 40, in response to receiving the final acceptance of the payment from the user device 10, may be configured to return the OTP, as received from the payment gateway server 20, to the payment gateway server 20. The payment gateway server 20, in response to determining that the returned OTP matches the generated OTP, is configured to extract the virtual number from the first mapping information which corresponds with the user information received from the merchant server 40, and transmit the extracted virtual number to the card issuer server 30. The card issuer server 30 is configured to extract the card information from the second mapping information which corresponds with the virtual number received from the payment gateway server, and process the payment for the merchandise using the extracted card information.

According to the exemplary embodiments, the OTP may be generated by the card issuer server 30. When the user accesses the merchant server 40 and selects at least one of the merchandises sold at the merchant server 40 through the user device 10, then the user device 10 may transmit a transaction request to the merchant server 40. The transaction request includes a merchandise selection information and the user information. The merchant server 40 transmits the user information to the payment gateway server 20. The payment gateway server 20 is configured to extract the virtual number from the first mapping information which corresponds with the user information, and transmit the extracted virtual number to the card issuer server 30. The card issuer server 30, in response to receiving the virtual number, generates the OTP and transmits the OTP to user device 10. The user device 10 may provide the user with a user interface displaying the OTP received from the card issuer server 30 and receive a user input confirming the OTP. The user device 10, in response to the user input, transmits the user input confirming the OTP to the card issuer server 30. The card issuer server 30, in response to determining that the generated OTP matches the user input confirming the OTP, is configure to extract, the virtual number from the second mapping information which corresponds with the virtual number received from the payment gateway server 20, and process the payment for the merchandise using the extracted card information.

According to the exemplary embodiments, the OTP may be generated by the card issuer server 30. When the user accesses the merchant server 40 and selects at least one of the merchandises sold at the merchant server 40 through the user device 10, then the user device 10 may transmit a transaction request to the merchant server 40. The transaction request includes a merchandise selection information and the user information. The merchant server 40 transmits the user information to the payment gateway server 20. The payment gateway server 20 is configured to extract the virtual number from the first mapping information which corresponds with the user information, and transmit the extracted virtual number to the card issuer server 30. The card issuer server 30, in response to receiving the virtual number, generates the OTP and transmits the OTP to user device 10. The user device 10, in response to receiving the OTP from the card issuer server 30, may provide the user with a user interface to receive a final acceptance of the payment from the user confirming the payment. The user device 10, in response to receiving the final acceptance of the payment from the user, may be configured to return the OTP as received from the card issuer server 30 to the card issuer server 30. The card issuer server 30, in response to determining that the returned OTP matches the generated OTP, is configured to extract the virtual number from the second mapping information which corresponds with the virtual number received from the payment gateway server 20, and process the payment for the merchant using the extracted card information.

According to the exemplary embodiments, the OTP may be generated by the card issuer server 30. When the user accesses the merchant server 40 and selects at least one of the merchandises sold at the merchant server 40 through the user device 10, then the user device 10 may transmit a transaction request to the merchant server 40. The transaction request includes merchandise selection information and the user information. The merchant server 40 transmits the user information to the payment gateway server 20. The payment gateway server 20 is configured to extract the virtual number from the first mapping information which corresponds with the user information, and transmit the extracted virtual number to the card issuer server 30. The card issuer server 30, in response to receiving the virtual number, generates the OTP, and then transmits the OTP to the merchant server 40. The merchant server 40, in response to receiving the OTP from the card issuer server 30, is configured to transmit a request for final acceptance of the payment to the user device 10. The user device 10, in response to receiving the request for final acceptance of the payment from the merchant server 40, may be configured to provide the user with a user interface to receive the final acceptance of the payment from the user. The user device 10, in response to receiving the final acceptance of the payment from the user, may be configured to transmit the final acceptance of the payment to the merchant server 40. The merchant server 40, in response to receiving the final acceptance of the payment from the user device 10, may be configured to return the OTP, as received from the card issuer server 30, to the card issuer server 30. The card issuer server 30, in response to determining that the returned OTP matches the generated OTP, is configured to extract the virtual number from the second mapping information corresponding with the virtual number received from the payment gateway server 20, and process the payment for the merchant using the extracted card information.

Exemplary embodiments of methods for electronic transactions using the above-described system will be described in detail.

FIG. 3 is a flow chart illustrating a method for electronic transaction according to one or more exemplary embodiments.

Referring to FIG. 1 and FIG. 3, the first mapping information is generated by correlating the user information and the virtual number to each other and stored in the payment gateway server 20, and the second mapping information is generated by correlating the card information and the virtual number to each other and stored in the card issuer server 30. (S100)

According to the exemplary embodiments, the storing the first and second mapping information may be performed by various methods generating the virtual number at different location.

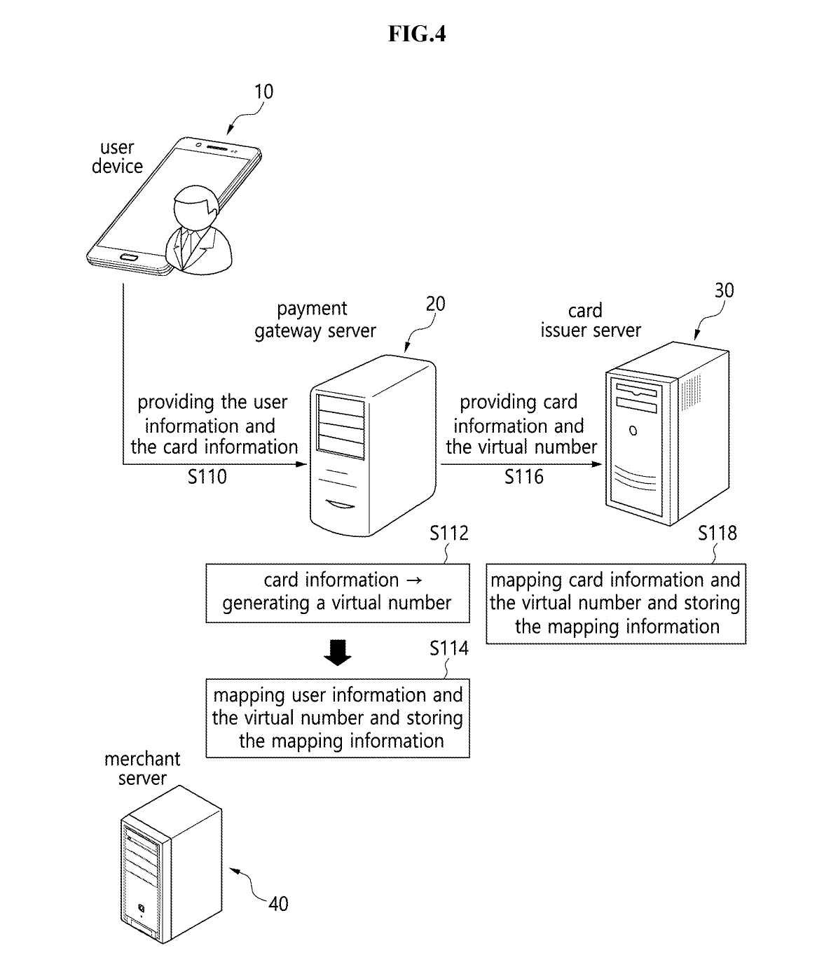

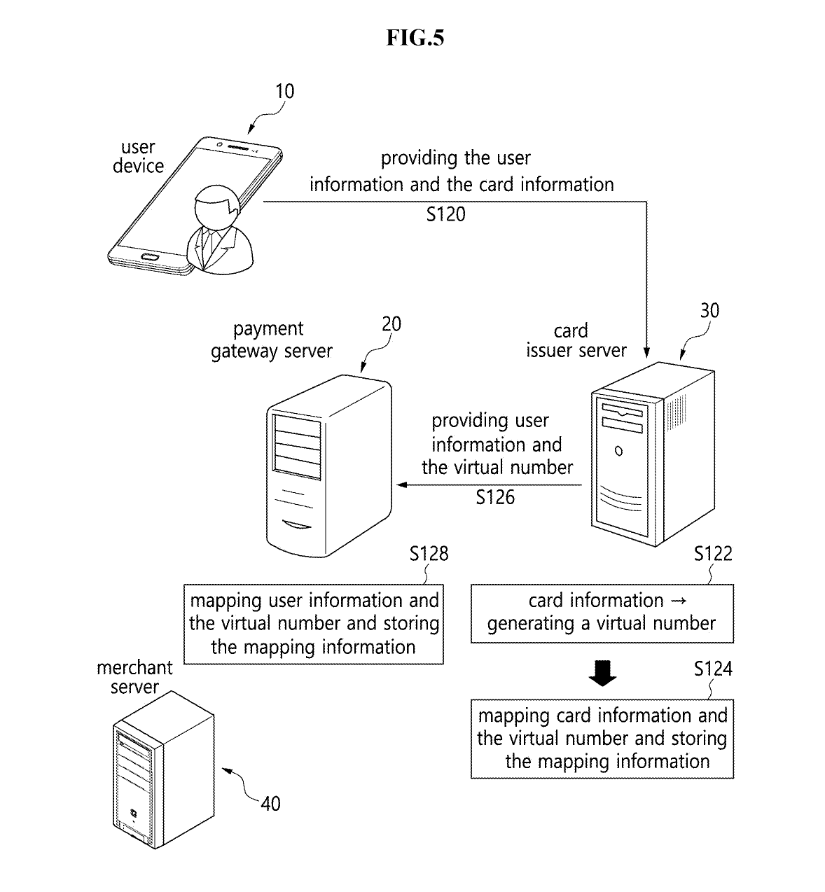

FIG. 4 is a diagram illustrating a first exemplary embodiment of storing the first and second mapping information of the FIG. 3.

Referring FIG. 4, the virtual number is generated by the payment gateway server 20. Then the first mapping information is generated and stored in the payment gateway server 20 and the second mapping information is generated and stored in the card issuer server 30.

More specifically, the user device 10 may transmit the user information and the card information, which may be stored in the user device 10 or input by the user, to the payment gateway server 20. (S110) The user information for the user A may include a user identification (ID). In the meantime, the user device 10 may also set a password for the electronic transaction service before or during the step S110 and transmit the password to at least one of the payment gateway server 20, the card issuer server 30, and the merchant server 40.

The payment gateway server 20 may generate the virtual number representing the card information received from the user device 10. (S112) For example, the payment gateway server 20 may generate a virtual number according to the predetermined generation rule or the random number generation.

The payment gateway server 20 is configured to generate the first mapping information by correlating the user information received from the user device and the virtual number generated by the payment gateway server 20 to each other, and store the first mapping information. (S114)

The payment gateway server 20 may transmit the card information and the virtual number to the card issuer server 30. (S116) The step S116 may be performed after S114, or before S114, or simultaneously with S114. Also, the payment gateway server 20 may delete the card information after transmitting the card information to the card issuer server 30.

The card issuer server 30 may be configured to generate the second mapping information by correlating the card information and the virtual number received from the payment gateway server 20 to each other, and store the second mapping information. (S118)

Therefore, the first exemplary embodiments provide enhanced security and improved protection against the risk of a security breach of the card information at the payment gateway server 20 because the payment gateway server 20 does not store card information, e.g. card number and account number.

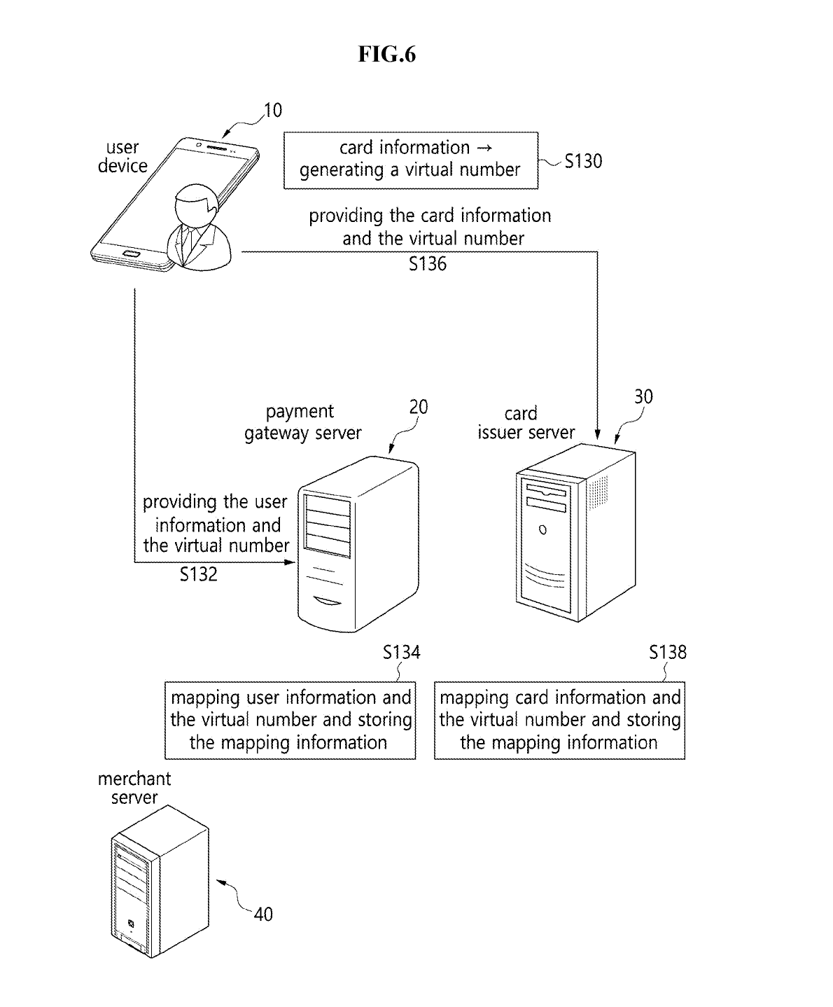

FIG. 5 is a diagram illustrating a second exemplary embodiment of the storing the first and second mapping information of the FIG. 3

Referring to FIG. 5, the virtual number is generated by the card issuer server 30. Then the first mapping information is generated and stored in the payment gateway server 20 and the second mapping information is generated and stored in the card issuer server 30.

More specifically, the user device 10 may transmit the user information and the card information, which may be stored in the user device 10 or input by the user, to the card issuer server 30. (S120) The user information of the user A may include the user ID. In the meantime, the user device 10 may also set the password for the electronic transaction service before or during the step S120 and transmit the password to at least one of the payment gateway server 20, the card issuer server 30, and the merchant server 40.

The card issuer server 30 may generate the virtual number representing the card information received from the user device 10. (S122) For example, the card issuer server 30 may generate a virtual number according to the predetermined generation rule or the random number generation.

The card issuer server 30 may be configured to generate the second mapping information by correlating the card information and the virtual number received from the card issuer server 30 to each other, and store the second mapping information. (S124)

The card issuer server 30 may transmit the user information and the virtual number to payment gateway server 20. (S126) The step S126 may be performed after S124, or before S124, or simultaneously with S124. Also, the card issuer server 30 may delete the user information after transmitting the user information to the payment gateway server 20.

The payment gateway server 20 may be configured to generate the first mapping information by correlating the user information and the virtual number, which are received from card issuer server 30, to each other, and store the first mapping information. (S128)

Therefore, the second exemplary embodiments may provide enhanced security and improved protection against the security breach of the card information at the payment gateway server 20 because the card information, e.g. card number and account number, is never provided at the payment gateway server.

FIG. 6 is a diagram illustrating a third exemplary embodiment of the storing the first and second mapping information of the FIG. 3.

Referring to FIG. 6, the virtual number is generated by the user device 10. Then the first mapping information is generated and stored in the payment gateway server 20 and the second mapping information is generated and stored in the card issuer server 30.

Specifically, the user device 10 may generate a virtual number representing the card information which is stored in the user device or input by the user. (S130) The user device may generate a virtual number according to the predetermined generation rule or the random number generation.

The user device 10, then, may transmit the user information and the virtual number to the payment gateway server 20. (S132) The user information of the user A may include the user ID of the user A. In the meantime, the user device 10 may also set the password for the electronic transaction service before or during the step S132 to transmit the password to at least one of the payment gateway server 20, the card issuer server 30, and the merchant server 40.

The payment gateway server 20 is configured to generate the first mapping information by correlating the user information and the virtual number, which are received from the user device 10, to each other, and store the first mapping information. (S134)

The user device 10 may transmit the card information and the virtual number to the card issuer server 30. (S136) The step S136 may be performed after S132, or before S132, or simultaneously with S132. Also, in order to transmit the card information and the virtual number to the card issuer server 30, the user device 10 may access the card issuer server 30 directly or via the payment gateway server 20.

The card issuer server 30 may be configured to generate the second mapping information by correlating the card information and the virtual number received from the user device 10 to each other, and store the second mapping information. (S138)

Therefore, the third exemplary embodiments may provide enhanced security and improved protection against the security breach of the card information at the payment gateway server 20 because the card information, e.g. card number and account number, is never provided for the payment gateway server.

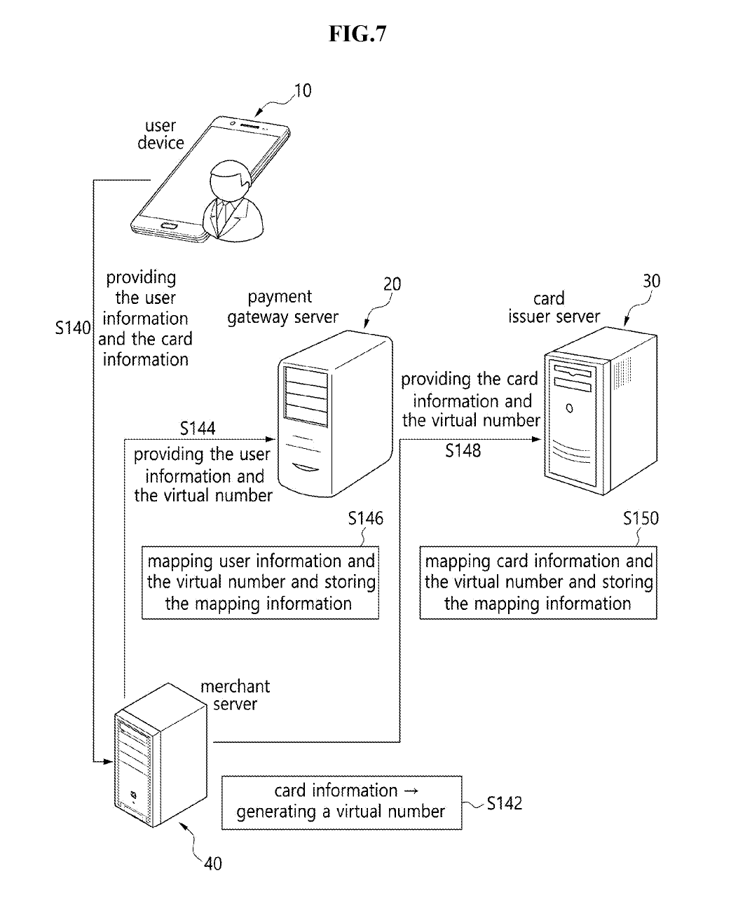

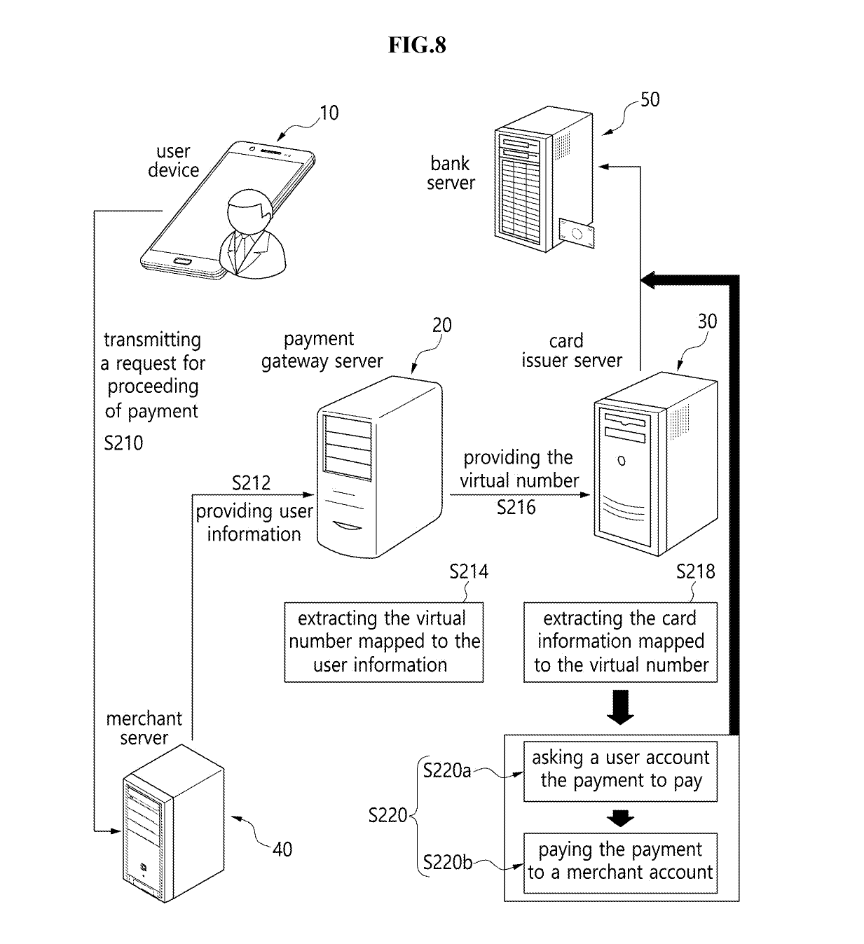

FIG. 7 is a diagram illustrating fourth exemplary embodiments of the storing the first and second mapping information of the FIG. 3.

Referring to FIG. 7, the virtual number is generated by the merchant server 40. Then the first mapping information is generated and stored in the payment gateway server 20 and the second mapping information is generated and stored in the card issuer server 30.

More specifically, the user device 10 may transmit the user information and the card information, which are stored in the user device 10 or input by the user, to the merchant server 40. (S140). The user device 10 may set the password for the electronic transaction service before or during the step S140 and transmit the password to at least one of the payment gateway server 20, the card issuer server 30, and the merchant server 40.

The user information of the user A may include a user ID and the password of the user A.

The payment the merchant server 40 may be configured to generate the virtual number representing the card account information received from the user device 10. (S142) The merchant server 40 may generate a virtual number according to the predetermined generation rule or the random number generation.

The merchant server 40 may transmit the user information received from the user device 10 and the generated virtual number to the payment gateway server 20. (S144) For example, in order to transmit the user information and the virtual number to the payment gateway server 20, the merchant server 40 may access the payment gateway server 20 directly or via the card issuer server 30.

The payment gateway server 20 is configured to generate the first mapping information by correlating the user information and the virtual number, which are received from the merchant server 40, to each other, and store the first mapping information. (S146)

The merchant server 40 may also transmit the card information received from the user device 10 and the generated virtual number to the card issuer server 30. (S144). For example, in order to transmit the card information and the virtual number to the card issuer server 30, the merchant server 40 may access the card issuer server 30 directly or via the payment gateway server 20.

The card issuer server 30 may be configured to generate the second mapping information by correlating the card information and the virtual number received from merchant server 40 to each other, and store the second mapping information. (S150)

The merchant server 40 may delete the card information after transmitting the card information to the card issuer server 30.

Therefore, the fourth exemplary embodiments may provide enhanced security and improved protection against the security breach of the card information at the payment gateway server 20 because the card information, e.g. card number and account number, is never provided at the payment gateway server.

Referring back to FIG. 3, after storing the first and second mapping information respectively to the payment gateway server 20 and the card issuer server 30, when user accesses the merchant server 40 and selects at least one of merchandises sold at the merchant server 40 through the user device, the payment is processed using the first mapping information stored in the payment gateway server 20 and the second mapping information stored in the card issuer server 30. (S200)

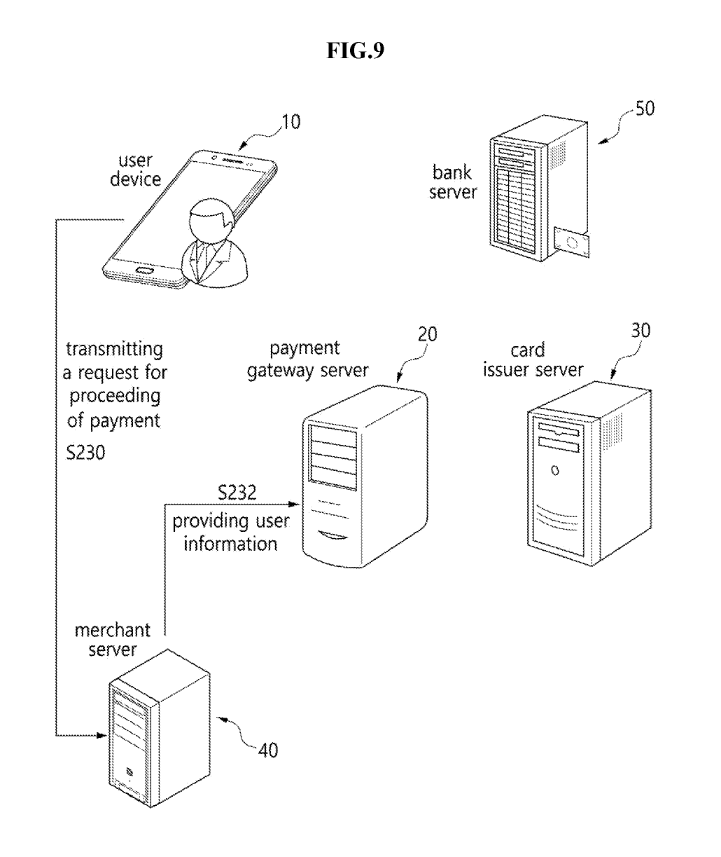

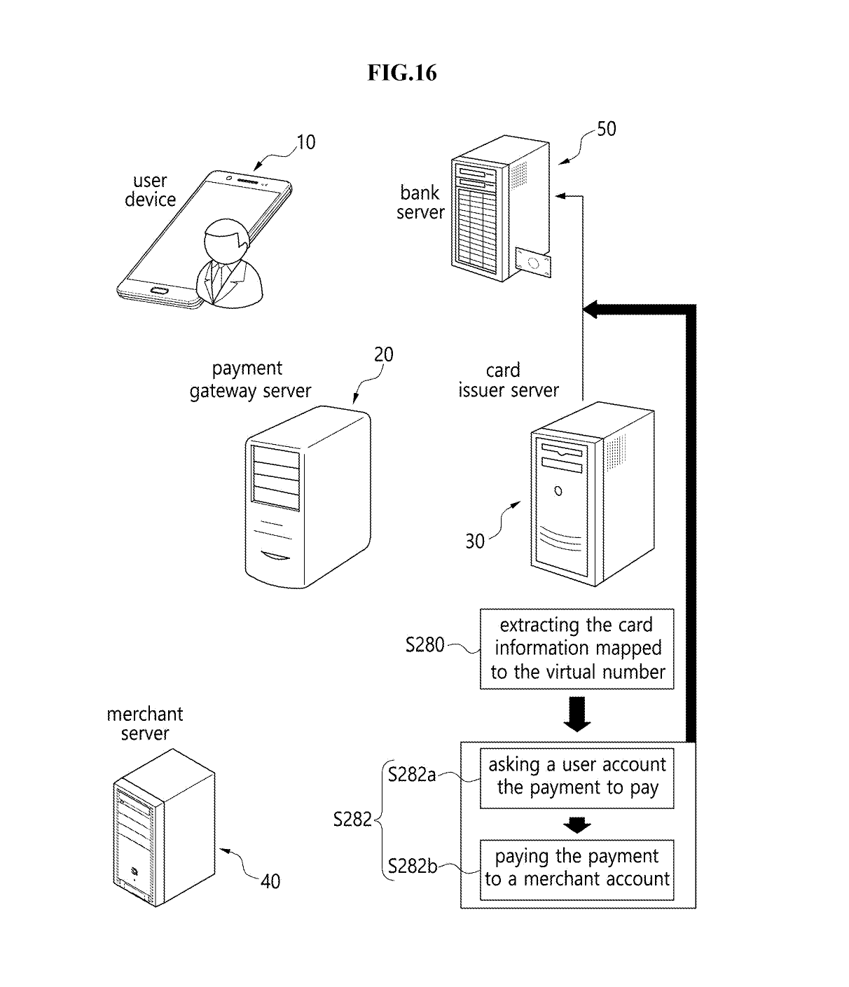

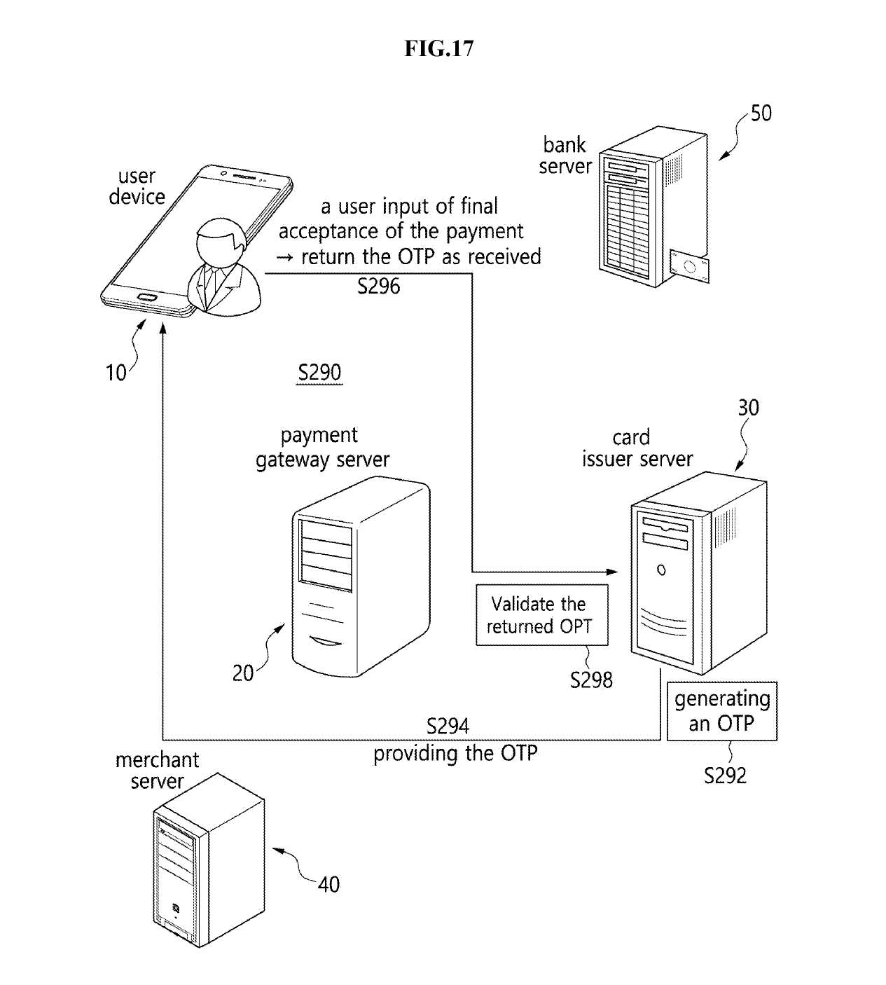

Hereinafter, processing a exemplary payment S200 will be described in detail referring FIG. 8 through 18.

FIG. 8 is a diagram illustrating an exemplary embodiment of the payment process of the FIG. 3.

Referring to FIG. 8, the user device 10 accesses the merchant server 40 and selects at least one of merchandises sold at the merchant server 40 through the user device 10. The user device 10 then may transmit a request for the payment process to the merchant server 40. (S210) The request for the payment process includes a merchandise selection information and the user information including the user ID. The user device 10 may also transmit a password corresponding to the user ID to the merchant server 40.

The merchant server 40 transmits the user information to the payment gateway server 20. (S212) The merchant server 40 may transmit the user information to the payment gateway server 20 only if the password transmitted from the user device 10 matches the password stored in the merchant server 40.

The payment gateway server 20 may extract the virtual number from the first mapping information which corresponds with the user information received from the merchant server 40. (S214)

The payment gateway server 20 then transmits the extracted virtual number to the card issuer server 30. (S216)

The card issuer server 30 may extract the card information from the second mapping information which corresponds with the virtual number received from the payment gateway server. (S218)

The card issuer server 30 then processes the payment for the merchandise using the extracted card information. (S200) For example, the card issuer server 30 may access the bank server 50 to request a user account associated with the card information of the user to make the payment. (S220a) Also, the card issuer server 30 may accesses the bank server 50 to make the payment to a merchant account associated with the merchant server 40. (S220b). The bank server 50 of the user account and the bank server 50 of the merchant account may be same or different.

The exemplary embodiments of the payment process using OTP will be described below.

First, the exemplary embodiments using the OTP generated by the payment gateway server 20 will be described in detail.

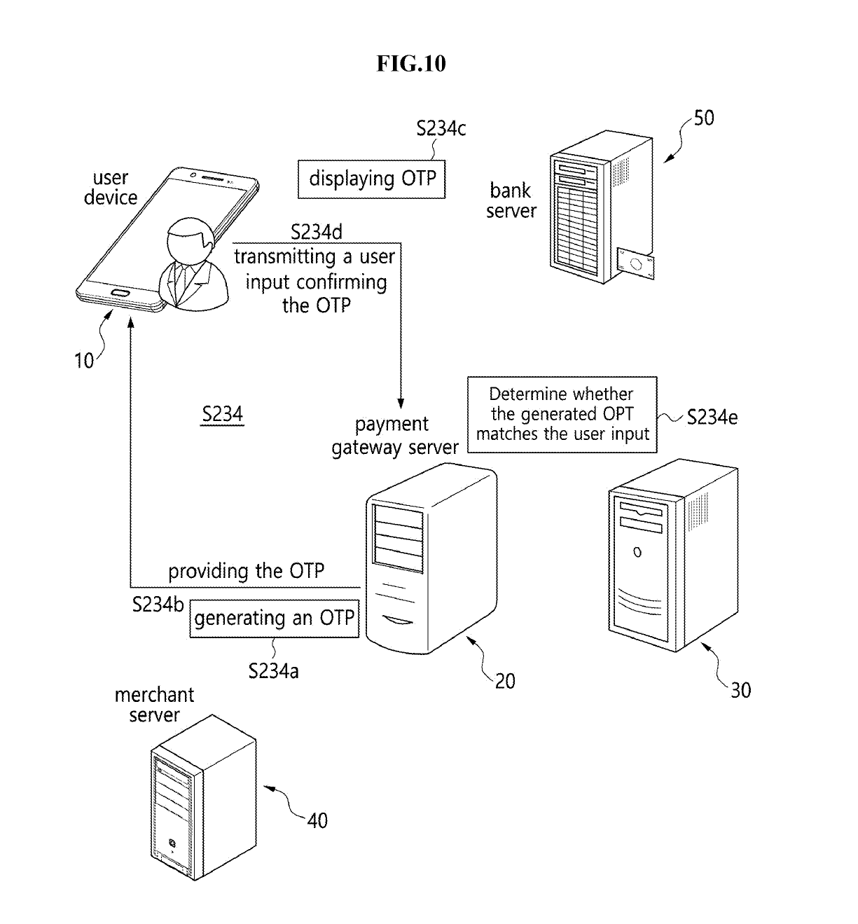

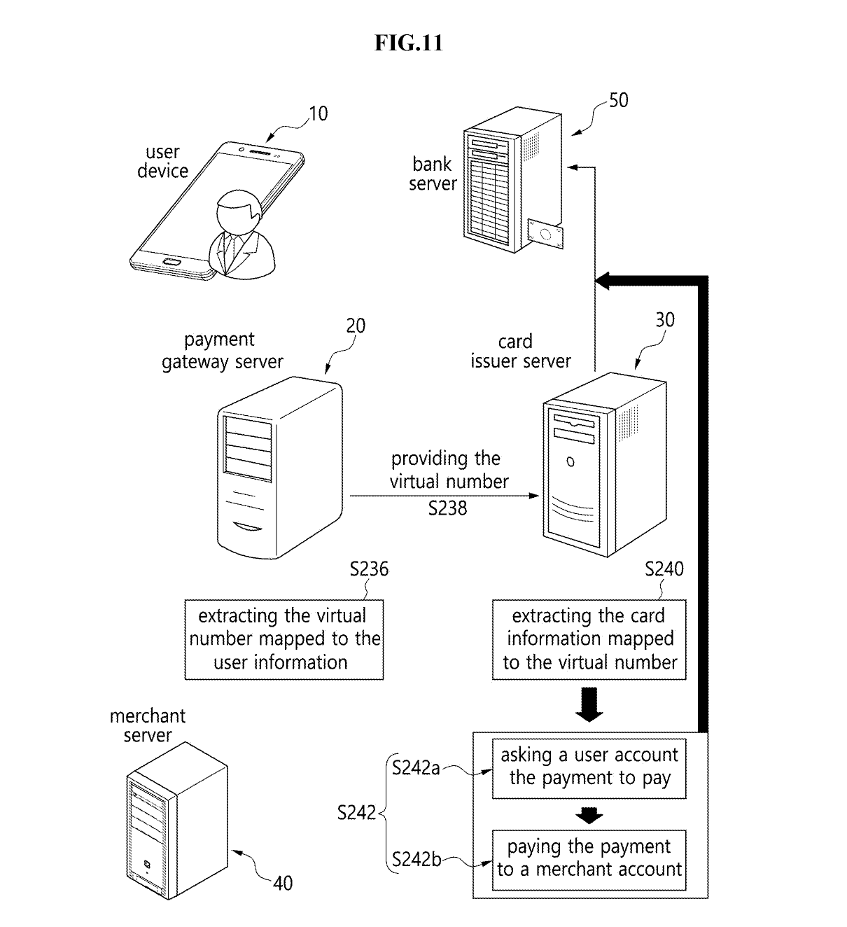

FIGS. 9, 10, and 11 are series of diagrams illustrating an exemplary embodiment of the payment process of the FIG. 3 using the OTP generated by the payment gateway server 10. More specifically, FIG. 9 is a diagram illustrating extracting the virtual number, FIG. 10 is a diagram illustrating confirming the OTP, and FIG. 11 is a diagram illustrating the payment process, executed in the provided order.

Referring to FIGS. 9, 10, and 11, the user device 10 accesses the merchant server 40 and selects at least one of merchandises sold at the merchant server 40 through the user device 10. The user device 10 then may transmit a request for the payment process to the merchant server 40 S230. The request for the payment process including the merchandise selection information and the user ID to the merchant server 40. The request for the payment process may also include the password corresponding to the user ID to the merchant server 40.

The merchant server 40 transmits the user information to the payment gateway server 20. (S232) The merchant server 40 may transmit the user information to the payment gateway server 20 only if the password transmitted from the user device 10 matches the password stored in the merchant server 40.

The payment gateway server 20, in response to receiving the user information, may perform a confirmation process using the OTP. (S214) The confirmation process using OTP S234 will be explained in more detail.

The payment gateway server 20, in response to receiving the user information, generates the OTP. (S234a) The OTP may include a random number or barcode generated based on a random number table. The payment gateway server 20 then may transmit the OTP to the user device 10. (S234b) The user device 10 may be configured to provide the user with a user interface displaying the OTP received from the payment gateway server 20, and receive a user input confirming the OTP. (S234c) The user device 10, in response to the user input, transmits the user input confirming the OTP to the payment gateway server 20. (S234d) The payment gateway server 20 determines whether the generated OTP matches the user input confirming the OTP. (S234e)

The payment gateway server 20 may extract the virtual number from the first mapping information which corresponds with the user information received from the merchant server 40. (S236) The step S236 may be performed after S234, before S234, or simultaneously with S234.

The payment gateway server 20, in response to determining that the generated OTP matches the user input confirming the OTP, may transmit the extracted virtual number to the card issuer server 30. (S238)

The card issuer server 30 extracts the card information from the second mapping information which corresponds with the virtual number received from the payment gateway server 20. (S240)

The card issuer server 30 then processes the payment for the merchandise using the extracted card information. (S242) For example, the card issuer server 30 may access the bank server 50 to request a user account associated with the card information of the user to make the payment. (S242a) Also, the card issuer server 30 may accesses the bank server 50 to make the payment to a merchant account associated with the merchant server 40. (S242b). The bank server 50 of the user account and the bank server 50 of the merchant account may be same or different.

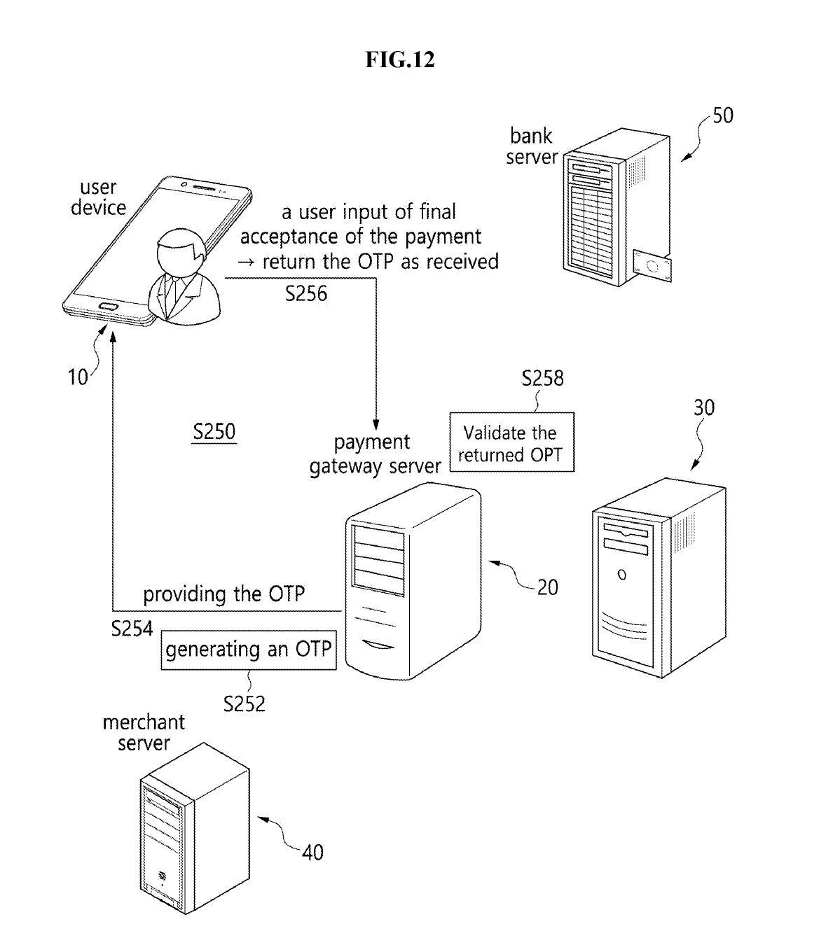

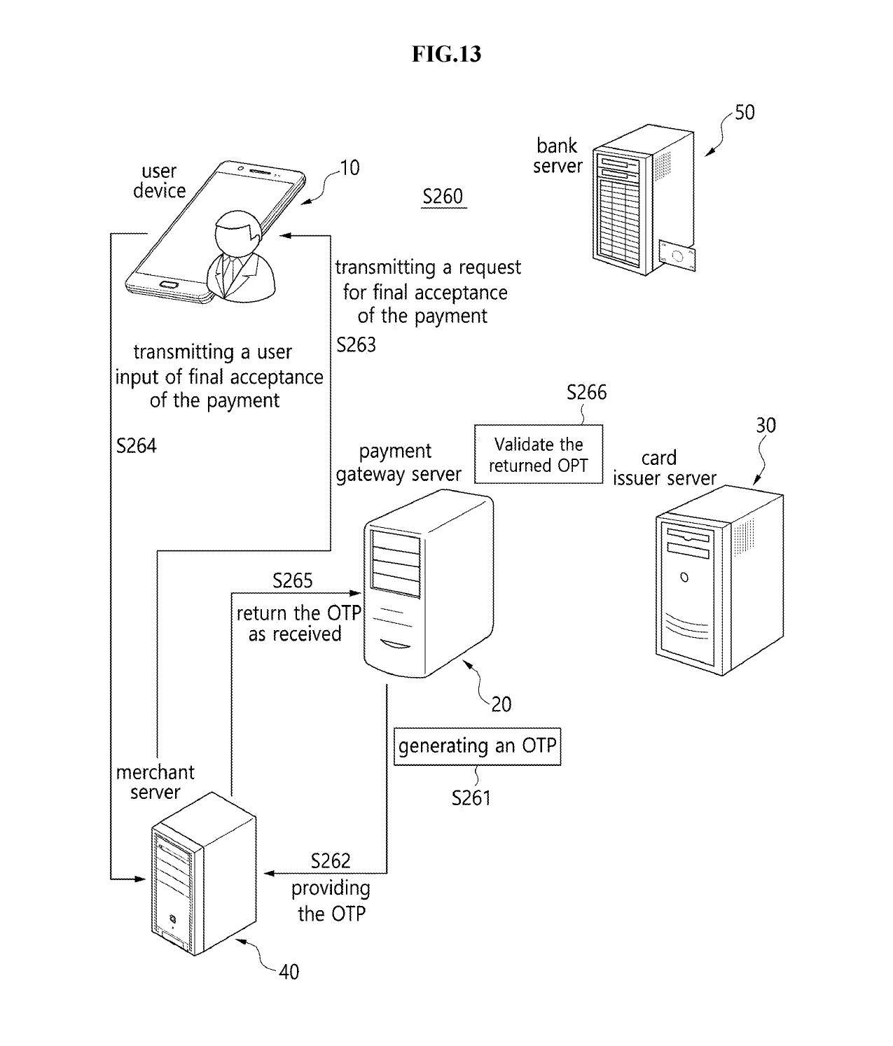

FIGS. 12 and 13 are diagrams illustrating exemplary embodiments of the payment process of the FIG. 3 using the OTP generated by the payment gateway server.

The exemplary embodiment illustrated of FIG. 12 is substantially same as the exemplary embodiment of FIG. 10, except that the step S234 of FIG. 10 is replaced with the step S250 of FIG. 12.

Referring to FIG. 12, after the step S232 of FIG. 10, the confirmation process using an OTP S250 is performed. The confirmation process using OTP S250 will be explained in more detail.

The payment gateway server 20, in response to receiving the user information from the merchant server 40, generates the OTP. (S252) The OTP may include a random number or barcode generated based on a random number table. The payment gateway server 20 then may transmit the OTP to the user device 10. (S254)

The user device 10, in response to receiving the OTP from the payment gateway server 20, is configured to provide the user with a user interface to receive the final acceptance of the payment from the user confirming the payment. The user device 10, in response to receiving the user input of final acceptance of the payment, returns the OTP, as received from the payment gateway server 20, to the payment gateway server 20. (S256)

The payment gateway server 20 validates the returned OTP by determining whether the returned OTP matches the generated OTP. (S258) The payment gateway server 20, in response to validating the returned OTP, is configured to extract the virtual number from the first mapping information which corresponds with the user information received from the merchant server 40, and transmit the extracted virtual number to the card issuer server 30. (S238) The card issuer server 30 is configured to extract the card information from the second mapping information corresponding with the virtual number received from the payment gateway server (S240), and then process the payment for the merchandise using the extracted card information. (S242)

The exemplary embodiment illustrated of FIG. 13 is substantially same as the exemplary embodiment of FIG. 10, except that the step S234 of FIG. 10 is replaced with the step S260 of FIG. 13.

Referring to FIG. 13, after the step S232 of FIG. 10, the confirmation process using an OTP S650 is performed. The confirmation process using OTP S250 will be explained in more detail.

The payment gateway server 20, in response to receiving the user information from the merchant server 40, generates the OTP. (S261) The OTP may include a random number or barcode generated based on a random number table. The payment gateway server 20 then may transmit the OTP to the merchant server 40. (S262)

The merchant server 40, in response to receiving the OTP from the payment gateway server 20, is configured to transmit a request for final acceptance of the payment to the user device 10. (S263)

The user device 10, in response to receiving the request for final acceptance of the payment from the merchant server 40, may be configured to provide the user with a user interface to receive the final acceptance of the payment from the user. The user device 10, in response to receiving the final acceptance of the payment from the user, may be configured to transmit the final acceptance of the payment to the merchant server 40. (S264).

The merchant server 40, in response to receiving the final acceptance of the payment from the user device 10, may be configured to return the OTP, as received from the payment gateway server 20, to the payment gateway server 20. (S265)

The payment gateway server 20 validates the returned OTP by determining whether the returned OTP matches the generated OTP. (S266) The payment gateway server 20, in response to validating the returned OTP, is configured to extract the virtual number from the first mapping information which corresponds with the user information received from the merchant server 40, and transmit the extracted virtual number to the card issuer server 30. (S238) The card issuer server 30 is configured to extract the card information from the second mapping information corresponding with the virtual number received from the payment gateway server (S240), and then process the payment for the merchandise using the extracted card information. (S242)

Second, the exemplary embodiments using the OTP generated by the card issuer server 30 will be described in detail

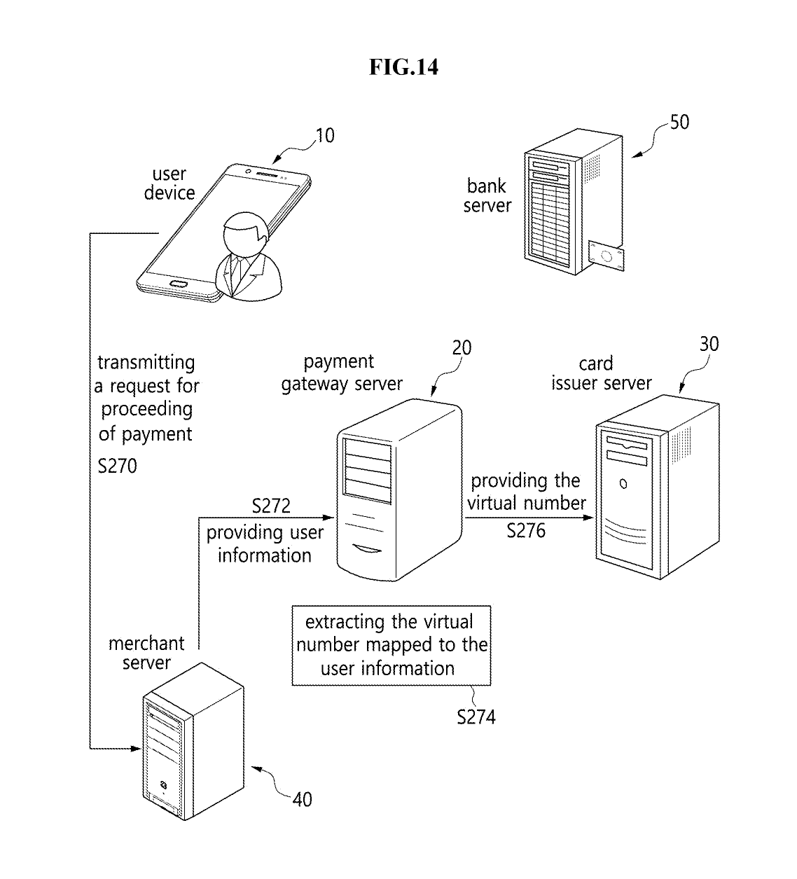

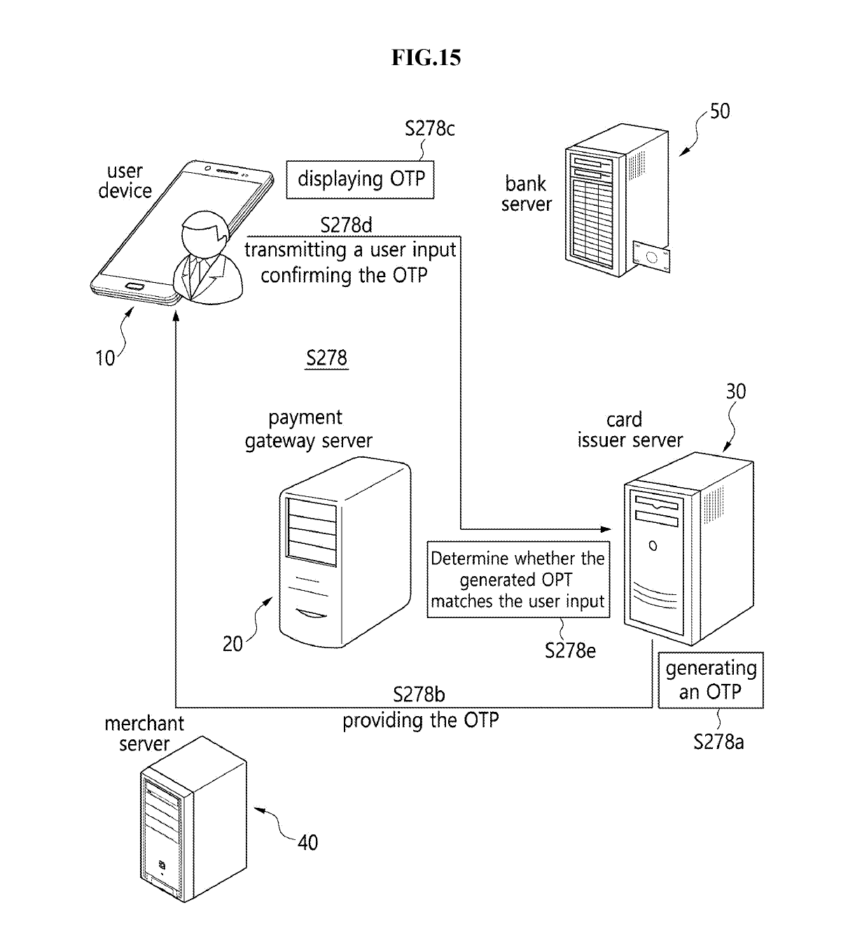

FIGS. 14, 15, and 16 are series of diagrams illustrating an exemplary embodiment of the payment process of the FIG. 3 using the OTP generated by the card issuer server 30. More specifically, FIG. 14 is a diagram illustrating extracting the virtual number, FIG. 15 is a diagram illustrating confirming the OTP, and FIG. 15 is a diagram illustrating the payment process, executed in the provided order.

Referring to FIGS. 14, 15, and 16, the user device 10 accesses the merchant server 40 and selects at least one of merchandises sold at the merchant server 40 through the user device 10. The user device 10 then may transmit a request for the payment process to the merchant server 40 S270. The request for the payment process including the merchandise selection information and the user ID to the merchant server. The request for the payment process may also include the password corresponding to the user ID to the merchant server 40.

The merchant server 40 transmits the user information to the payment gateway server 20. (S272) The merchant server 40 may transmit the user information to the payment gateway server 20 only if the password transmitted from the user device 10 matches the password stored in the merchant server 40.

The payment gateway server 20 extracts the virtual number from the first mapping information which corresponds with the user information received from the merchant server 40. (S274) The payment gateway server 20 transmits the extracted virtual number to the card issuer server 30.

The card issuer server 30, in response to receiving the virtual number, may perform a confirmation process using the OTP. (S278) The confirmation process using OTP S234 will be explained in more detail.

The card issuer server 30, in response to receiving the user information, generates the OTP. (S278a). The OTP may include a random number or barcode generated based on a random number table. The card issuer server 30 then may transmit the OTP to the user device 10. (S278b) The user device 10 may be configured to provide the user with a user interface displaying the OTP received from the card issuer server 30, and receive a user input confirming the OTP. (S278c). The user device 10, in response to the user input, transmits the user input confirming the OTP to the card issuer server 30. (S278d) The card issuer server 30 determines whether the OTP matches the user input confirming the OTP. (S278e)

The card issuer server 30, in response to determining that the generated OTP matches the user input confirming the OTP, extracts the card information from the second mapping information which corresponds with the virtual number received from the payment gateway server 20. (S280)

The card issuer server 30 then processes the payment for the merchandise using the extracted card information. (S282) For example, the card issuer server 30 may access the bank server 50 to request a user account associated with the card information of the user to make the payment. (S282a). Also, the card issuer server 30 may accesses the bank server 50 to make the payment to a merchant account associated with the merchant server 40. (S282b) The bank server 50 of the user account and the bank server 50 of the merchant account may be same or different.

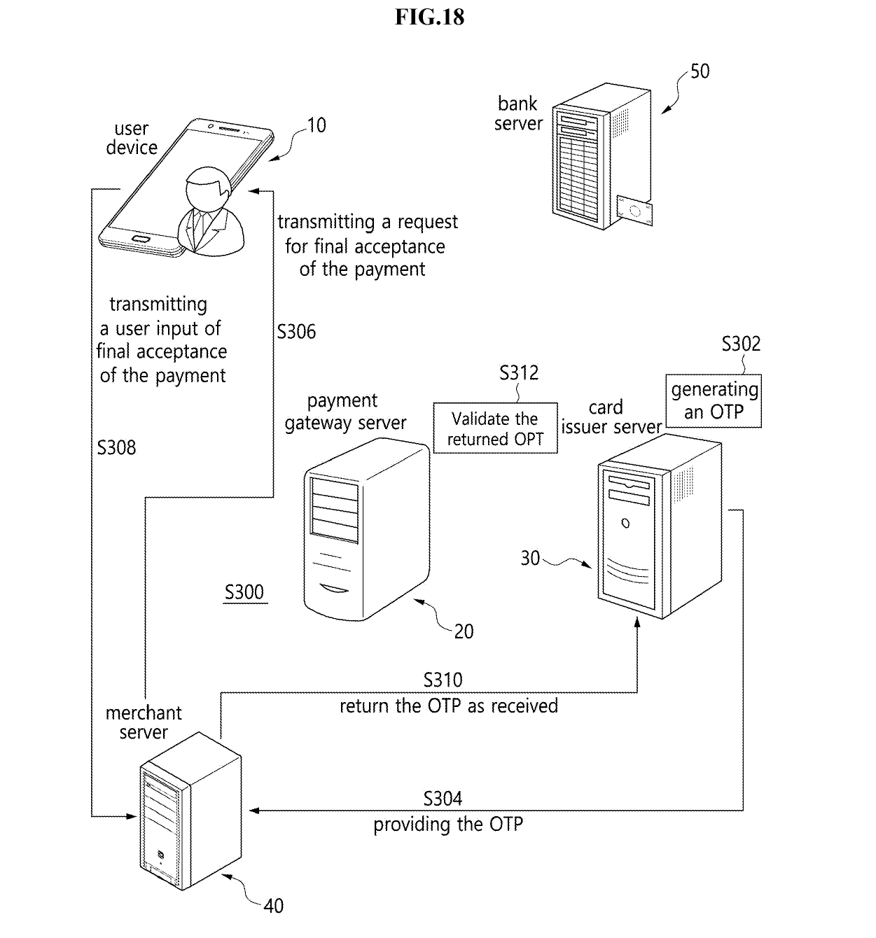

FIGS. 17 and 18 diagrams illustrating exemplary embodiments of the payment process of the FIG. 3 using the OTP generated by the card issuer server.

The exemplary embodiment illustrated of FIG. 17 is substantially same as the exemplary embodiment of FIG. 10, except that the step S278 of FIG. 15 is replaced with the step S290 of FIG. 17.

Referring to FIG. 17, after the step S276 of FIG. 15, the confirmation process using an OTP S290 is performed. The confirmation process using OTP S290 will be explained in more detail.

The card issuer server 30, in response to receiving the virtual number from the payment gateway server 20, generates the OTP. (S292). The OTP may include a random number or barcode generated based on a random number table. The card issuer server 30 then may transmit the OTP to the user device 10. (S294)

The user device 10, in response to receiving the OTP from card issuer server 30, configured to provide the user with a user interface to receive the final acceptance of the payment from the user confirming the payment. The user device 10, in response to receiving the user input of final acceptance of the payment, returns the OTP, as received from the payment gateway server 20, to the card issuer server 30. (S256)

The card issuer server 30 validates the returned OTP by determining whether the returned OTP matches the generated OTP. (S258) The card issuer server 30, in response to validating the returned OTP, is configured to extract the card information from the second mapping information which corresponds with the virtual number received from the payment gateway server 20 (S280), then processes the payment for the merchandise using the extracted card information. (S282)

The exemplary embodiment illustrated of FIG. 18 is substantially same as the exemplary embodiment of FIG. 10, except that the step S278 of FIG. 15 is replaced with the step S300 of FIG. 18.

Referring to FIG. 18, after the step S276 of FIG. 15, the confirmation process using an OTP S300 is performed. The confirmation process using OTP S290 will be explained in more detail.

The card issuer server 30, in response to receiving the virtual number from the payment gateway server 20, generates the OTP. (S302). The OTP may include a random number or barcode generated based on a random number table. The card issuer server 30 then may transmit the OTP to the merchant server 40. (S304)

The merchant server 40, in response to receiving the OTP from the card issuer server 30, is configured to transmit a request for final acceptance of the payment to the user device 10. (S263)

The user device 10, in response to receiving the request for final acceptance of the payment from the merchant server 40, may be configured to provide the user with a user interface to receive the final acceptance of the payment from the user. The user device 10, in response to receiving the final acceptance of the payment from the user, may be configured to transmit the final acceptance of the payment to the merchant server 40. (S308)

The merchant server 40, in response to receiving the final acceptance of the payment from the user device 10, may be configured to return the OTP, as received from the card issuer server 30, to the card issuer server 30. (S310)

The card issuer server 30 validates the returned OTP by determining whether the returned OTP matches the generated OTP. (S312) The card issuer server 30, in response to validating the returned OTP, is configured to extract, the card information from the second mapping information which corresponds with the virtual number received from the payment gateway server 20 (S280), then processes the payment for the merchandise using the extracted card information. (S282)

According to the exemplary embodiments of FIG. 10-18, the electronic transaction system may provide further enhanced security and improved protection by using the OTP in addition to using the virtual number.

For example, the electronic transaction system configured to process the payment using the virtual number to provide enhanced security and improved protection for the card information, e.g., card number and account number, may still have risk of fraud. The electronic transaction system using the OTP according to the exemplary embodiments may reduce the risk of fraud since security breach would require that the OTP and the virtual number be stolen or compromised simultaneously.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A method for enhancing a security in an electronic transaction system comprising a first server and a second server connected over an unsecured network, the method comprising:
receiving a user information and a user account number;
generating a virtual number based on the user account number, the virtual number representing the user account number;
generating a user mapping information by associating the virtual number and the user information to each other;
generating a account mapping information by associating the virtual number and the user account number;
storing the user mapping information in a first server; and
storing the account mapping information in a second server distinct from the first server.

2. The method of claim 1, wherein the step of generating the virtual number comprises:
transmitting the user information and the user account number to the first server;
generating, in the first server, the virtual number.

3. The method of claim 2, wherein the generating the virtual number further comprising:
transmitting, from the first server to the second server, the virtual number and the user account number.

4. The method of claim 3, the method further comprising:
deleting the user account number from the first server after transmitting the user account number to the second server.

5. The method of claim 1, wherein the step of generating the virtual number comprises:
transmitting the user information and the user account number to the second server;
generating, in the second sever, the virtual number.

6. The method of claim 5, wherein the step of generating the virtual number further comprises:
transmitting, from the second server to the first server, the virtual number and the user information.

7. The method of claim 6, the method further comprising:
deleting the user information from the second server after transmitting the user information to the second server.

8. The method of claim 1, wherein the generating the virtual number comprises:
generating, in a user device, the virtual number.

9. The method of claim 8, wherein the first server is a payment gateway server, the second server is a card issuer server and the step of generating the virtual number further comprises:
transmitting the virtual number and the user information from the user device to the payment gateway server; and
transmitting the virtual number and the account number from the user device to the card issuer server.

10. The method of claim 1, wherein the step of generating the virtual number comprises:
transmitting the user information and the user account number to a third server distinct from the first and second servers;
generating, in the third server, the virtual number.

11. The method of claim 10, wherein the first server is a payment gateway server, the second server is a card issuer server, the third server is a merchant server, and the step of generating the virtual number further comprises:
transmitting the virtual number and the user information from the merchant server to the payment gateway server; and
transmitting the virtual number and the account number from the merchant server to the card issuer server.

12. The method of claim 11, the method further comprising:
deleting the user account number from the merchant server, after transmitting the user account number to the card issuer server.

13. The method of claim 1, the method further comprising:
transmitting a request for a payment received from a user to a merchant server, the request for payment comprising the user information and merchandise selection information;
providing the user information to the first server;
extracting, by the first server, the virtual number from the user mapping information corresponding to the received user information;
transmitting the extracted virtual number to the second server;
extracting, by the second server, the user account number from the account mapping information corresponding to the virtual number; and
processing the payment using the extracted user account number.

14. The method of claim 13, wherein the first server is a payment gateway server, and the second server is a card issuer server, and the step of processing the payment further comprises:
accessing a bank server to request a user account associated with the card account information of the user to make the payment; and
accessing the bank server to make the payment to a merchant account associated with the merchant server.

15. The method of claim 13, the method further comprising the step of generating an one time password (OTP) to validate at least one of the user device and the merchant server.

16. The method of claim 15, wherein the step of generating the OTP comprises:
generating, by the first server, the OTP;
transmitting the generated OTP to the user device;
displaying, by the user device, the generated OTP and a user interface to the user to receive a user input confirming the OTP; and
transmitting the user input confirming the OTP from the user device to the first server;
validating the user input confirming the OTP by determining whether the user input confirming the OTP matches the generated OTP, and
wherein the step of transmitting the extracted virtual number to the second server further comprises transmitting the extracted virtual number to the second server in response of validation of the user input confirming the OTP.

17. The method of claim 15, wherein the step of generating the OTP comprises:
generating, by the first server, the OTP;
transmitting the generated OTP from the first server to the user device;
displaying, by the user device, a user interface to the user to receive a user input of final acceptance of the payment;
returning, by the user device, the OTP as received to the first server in response to receiving the user input of final acceptance of the payment through the user interface; and
validating the user input of final acceptance of the payment by determining whether the returned OTP matches the generated OTP, and
wherein the step of transmitting the extracted virtual number to the second server further comprises transmitting the extracted virtual number to the second server in response of validation of the user input of final acceptance.

18. The method of claim 15, wherein the step of generating the OTP comprises:
generating, by the first server, the OTP;
transmitting the generated OTP from the first server to a merchant server;
transmitting a request for final acceptance of the payment from the merchant server to the user device,
displaying, by the user device, a user interface to the user to receive a user input of final acceptance of the payment in response to receiving the request for final acceptance of the payment from the merchant server;
transmitting the user input of the final acceptance of the payment from the user device to the merchant server;
returning, by the merchant server, the OTP as received to the first server in response to receiving the user input of the final acceptance of the payment from the user device; and
validating the user input of final acceptance of the payment by determining whether the returned OTP matches the generated OTP, and
wherein the step of transmitting the extracted virtual number to the second server further comprises transmitting the extracted virtual number to the second server in response of validation of the user input of final acceptance.

19. The method of claim 15, wherein the step of generating the OTP comprises:
generating, by second server, the OTP;
transmitting the generated OTP from the second server to the user device;
displaying, by the user device, the generated OTP and a user interface to the user to receive a user input confirming the OTP; and
transmitting the user input confirming the OTP from the user device to the second server;
validating the user input confirming the OTP by determining whether the user input confirming the OTP matches the generated OTP, and
wherein the step of processing the payment using the extracted user account number further comprises processing the payment using the extracted user account number in response of validation of the user input confirming the OTP.

20. The method of claim 15, wherein the step of generating the OTP comprises:
generating, by the second server, the OTP;
transmitting the generated OTP from the second server to the user device;
displaying, by the user device, a user interface to the user to receive a user input of final acceptance of the payment; and
returning, by the user device, the OTP as received to the second server in response to receiving the user input of final acceptance of the payment through the user interface; and
validating the user input of final acceptance of the payment by determining whether the returned OTP matches the generated OTP, and
wherein the step of processing the payment using the extracted user account number further comprises processing the payment using the extracted user account number in response of validation of the user input of final acceptance.

21. The method of claim 15, wherein the step of generating the OTP comprises:
generating, by the second server, the OTP;
transmitting the generated OTP from the second server to a merchant server;
transmitting a request for final acceptance of the payment from the merchant server to the user device,
displaying, by the user device, a user interface to the user to receive a user input of final acceptance of the payment in response to receiving the request for final acceptance of the payment from the merchant server;
transmitting the user input of the final acceptance of the payment from the user device to the merchant server;
returning, by the merchant server, the OTP as received to the second server in response to receiving the user input of the final acceptance of the payment from the user device; and
validating the user input of final acceptance of the payment by determining whether the returned OTP matches the generated OTP, and
is wherein the step of processing the payment using the extracted user account number further comprises processing the payment using the extracted user account number in response of validation of the user input of final acceptance.

22. An electronic transaction system for enhancing security protection of an electronic transaction in an unsecured, online environment, said electronic transaction system comprising:
a payment gateway server comprising a database comprising a user mapping information,
wherein the user mapping information comprises a user information and a virtual number mapped to each other, and
wherein the payment gateway server is configured to receive the user information and extract the virtual number from the user mapping information which corresponds to the received user information.

23. The electronic transaction system of claim 22, wherein the payment gateway server is further configured to:
receive the user information and the virtual number;
generate the user mapping information by mapping the user information and the virtual number; and
store the user mapping information in the database.

24. The electronic transaction system of claim 22, wherein the payment gateway server is further configured to:
receive the user information and a user account information;
generate the virtual number, the virtual number representing the user account information;
generate the user mapping information by mapping the user information and the virtual number;
store the user mapping information in the database;
transmit the user account information to a card issuer server; and
delete the user account information after the user account information is sent to the card issuer server.

25. The electronic transaction system of claim 22, wherein the payment gateway server is further configured to:
generate an one time password (OTP);
transmit the generated OTP to a user device;
receive a user input confirming the OTP from the user device;
validate the user input confirming the OTP by determining whether the user input confirming the OTP matches the generated OTP; and
transmit the extracted virtual number to the card issuer server in response of validation of the user input confirming the OTP.

26. The electronic transaction system of claim 22, wherein the payment gateway server is further configured to:
generate an one time password (OTP);
transmit the generated OTP to a merchant server;
receive an OTP returned from the merchant server;
validate the returned OTP by determining whether the returned OTP matches the generated OTP; and
transmit the extracted virtual number to the card issuer server in response of validation of the returned OTP.

27. An electronic transaction system for enhancing security protection of an electronic transaction in an unsecured online environment, said electronic transaction system comprising:
a card issuer server comprising a database comprising an account mapping information,
wherein the account mapping information comprises a user account information and a virtual number mapped to each other, and
wherein the card issuer server is configured to receive the virtual number and extract the user account information from the account mapping information which corresponds to the received virtual number.

28. The electronic transaction system of claim 27, wherein the card issuer server is further configured to:
receive the user account information and the virtual number;
generate the account mapping information by mapping the user account information and the virtual number; and
store the account mapping information in the database.

29. The electronic transaction system of claim 27, wherein the card issuer server is further configured to:
receive the user account information and the user information;
generate the virtual number, the virtual number representing the user account information;
generate the user account mapping information by mapping the user account information and the virtual number;
store the user account mapping information in the database;
transmit the user information to a payment gateway server; and
delete the user information after the user information is sent to the payment gateway server.

30. The electronic transaction system of claim 27, wherein the card issuer server is further configured to:
generate an one time password (OTP);
transmit the generated OTP to a user device;
receive a user input confirming the OTP from the user device;
validate the user input confirming the OTP by determining whether the user input confirming the OTP matches the generated OTP; and
process the payment using the extracted user account number in response of validation of the user input of final acceptance.

31. The electronic transaction system of claim 27, wherein the card issuer server is further configured to:
generate an one time password (OTP);
transmit the generated OTP to a merchant server;
receive an OTP returned from the merchant server;
validate the returned OTP by determining whether the returned OTP matches the generated OTP; and
process the payment using the extracted user account number in response of validation of the returned OTP.
